(19) United States
(12) Patent Application Publication
(10) Pub. No.: US 2016/0310895 A1
(43) Pub. Date: Oct. 27, 2016

(54) Zeolite Catalysts Containing Titanium For The Oxidation Of Methane In Exhaust Gas Streams

(71) Applicant: CLARIANT INTERNATIONAL LTD, Muttenz (CH)

(72) Inventors: Arno TISSLER, Tegernheim (DE); Frank KLOSE, Rosenheim (DE); Roderik ALTHOFF, Rosenheim (DE); Beate ARENDT, Taufkirchen (DE); Sascha PODEHL, Kiefersfelden (DE); Patrick MUELLER, Frasdorf (DE)

(73) Assignee: Clariant International Ltd., Muttenz (CH)

(21) Appl. No.: 15/105,731

(22) PCT Filed: Dec. 8, 2014
(86) PCT No.: PCT/EP2014/076934

§ 371 Date: Jun. 17, 2016

(30) Foreign Application Priority Data
Dec. 20, 2013 (DE) 10 2013 021 750.4

(51) Int. Cl. B01D 53/86; B01J 35/04; B01J 29/89

(52) U.S. Cl. CPC B01D 53/8668; B01J 29/89; B01J 35/04; B01D 2255/50; B01D 2255/1023; B01D 2255/1021; B01D 2257/7025

(57) ABSTRACT

A method for the oxidation of short-chain hydrocarbons, in particular methane. The method uses a catalyst comprising a zeolite material which contains titanium and at least two noble metals. The invention also relates to the use of the catalyst for the oxidation of short-chain hydrocarbons, in particular methane, in exhaust gas streams.

The present invention relates to a method of oxidizing short-chain hydrocarbons, in particular methane, in which a catalyst comprising a zeolite material which contains titanium and at least two noble metals is used. The present invention further relates to the use of this catalyst for oxidizing short-chain hydrocarbons, in particular methane in exhaust gas streams.

Methane, which occurs in traces (i.e. less than 2 ppm) in the atmosphere, is a greenhouse gas which in this respect is more active by a factor of 25 than CO₂. Its emission due to nonnatural processes (“anthropogenic methane”) should therefore be reduced or avoided as far as possible. Anthropogenic methane is formed first and foremost in agriculture, in the conveying of natural gas, e.g. as result of leakages, and in the incomplete combustion of natural gas, e.g. in burners or engines. Typical industrial applications which produce methane-containing exhaust gas streams are mobile or stationary gas combustion engines or gas power stations as are used, for example, for power generation but also serve for heating, for example, greenhouses. The methane content in the exhaust gas streams can be reduced effectively by catalytic oxidation by means of oxygen.

Noble metal-containing oxidation catalysts for exhaust gas purification both in stationary and in mobile applications are known in the prior art. These noble metal-containing oxidation catalysts are sometimes also suitable for oxidizing short-chain hydrocarbons such as methane. The use of noble metals which are present in dispersed form on a support material is known, with metal oxides or zeolites being used as support material. Usually, a washcoat of the support material is first produced and is applied to a shaped body, usually ceramic or metal substrates, (e.g. honeycomb bodies), or to bulk material. The resulting coated shaped bodies are subsequently impregnated with a noble metal solution and the finished catalyst is obtained after an optional drying step and final calcinations of the shaped body.

As an alternative, the noble metal component can also be applied directly to the support material and, after a drying step, fixed by calcination. The impregnated support material is subsequently processed to produce a noble metal-containing washcoat which is applied to a shaped body or after shaping forms an all-active catalyst. The finished catalyst is obtained after an optional drying step and the final calcinations of the shaped body or all-active catalyst.

Noble metals used in oxidation catalysts are frequently the noble metals of transition group 8, including, in particular, Pt. The noble metals in the finished catalyst are usually present as metal clusters, i.e. in finely divided form.

DE 102008057134 A1 relates to new types of metal-containing silicates, in particular redox-active and also crystalline silicates, a process for producing metal-containing crystalline silicates and also their use as high-temperature oxidation catalyst or diesel oxidation catalyst. The process for producing metal-contained crystalline silicates is characterized in that a metal is introduced into a gallosilicate, gallotitanosilicate, borosilicate or borotitanosilicate and the gallosilicate, gallotitanosilicate, borosilicate or borotitanosilicate is subsequently calcined. A catalytic composition and also a shaped catalyst body containing the metal-containing crystalline silicates are also described.

Mori et al. (Studies in Surface Science in Catalysis (2007), 170 B, pp. 1319-1324) describe metal nanoparticles composed of platinum and palladium which are deposited under UV irradiation by a photo-assisted deposition (PAD) process onto titanium-containing zeolite materials (Ti-HMS and TS-1). The metals having a size in the nanometer range were deposited directly onto the tetrahedrally coordinated titanium dioxide moieties which had been excited by irradiation within the lattice. Characterization by means of XAFS and TEM analysis show that the size of the metal particles is dependent on the production process and that, compared to catalysts produced conventionally by impregnation, metal particles having a smaller size are formed on the catalysts produced by the photodeposition process. These nanometal catalysts can be used as active catalysts in various reactions such as the oxidation of carbon monoxide and the direct synthesis of H₂O₂ from H₂ and O₂ under aqueous conditions.

WO 2007037026 A1 describes a process for producing a catalyst by means of the steps of suspension of a titanium-containing porous silicate material in a solution in which a metal salt has been dissolved and of irradiation with UV radiation in order to bring about precipitation and deposition of finely divided microparticles on the surface of the titanium-containing porous silicate material and attain a satisfactory improvement in the catalytic activity. A catalyst which has been obtained in this way and has a satisfactorily improved catalytic activity is also described.

WO 95/11726 A1 relates to a method and a catalyst composition for destroying volatile organic compounds (VOCs). The method comprises the step of contacting the VOCs with an oxygen-containing gas in the presence of a catalyst which is a metal-exchanged, metal-impregnated aluminum silicate zeolite having at least one exchanged metal selected from the group consisting of Ti, V, Cr, Co, Ni, Cu, Fe, Mo, Mn, Pd and Pt in the zeolite and at least one impregnated metal selected from the group consisting of Ti, V, Cr, Mn, Fe, Co, Ni, Cu, Mo, Pd and Pt in the zeolite, where the difference between the exchanged metal and the impregnated metal has an influence on the temperature which is necessary to promote the oxidation of compounds during a contact time which is necessary to oxidize the compounds. The reaction temperature in the method can be in the range from about 100° C. to about 650° C. and the contact time can be in the range from about 0.01 to 20 seconds. The reaction temperature is preferably in the range from about 150° C. to about 450° C. and the contact time is from about 0.1 to 1.0 seconds. The CO/CO₂ ratio and the Cl₂/HCl ratio in the gaseous effluent can be altered by selection of at least two impregnated metals with at least one exchanged metal in the aluminum silicate zeolite or by the use of at least one impregnated metal with at least two exchanged metals in the aluminum silicate zeolite.

DE 102012003032.0 A1 relates to a process for producing a bimetallic catalyst containing palladium and platinum on a zeolitic support material, a bimetallic catalyst obtainable by the process and also the use of the catalyst in catalysis of oxidation. The process for producing the bimetallic catalyst comprises the steps of a) impregnation of a zeolitic support material with sulfur-free Pt and Pd precursor compounds, b) drying of the impregnated zeolitic support material in air and c) calcination of the impregnated and dried zeolitic support material under protective gas. The catalyst can be used as oxidation catalyst for the oxidation of alkanes.

The structures of some zeolites are thermally stable and thus suitable for use as support materials in exhaust gas catalysis. However, the structures of the zeolites can be damaged or destroyed at high temperatures in the simultaneous presence of gaseous water: this is referred to as a lack of hydrothermal stability. The destruction of the structure of the zeolite, e.g. by dealumination, leads to a reduction in the internal surface area of the zeolite, which is associated with deactivation of the catalyst. The breakdown of the zeolite structure leads to sintering of the metal clusters and these lose their optimal size and larger clusters having a reduced active surface area are formed. The lack of hydrothermal stability is a problem particularly in the oxidative catalytic treatment of exhaust gas since not only CO₂ and carbon monoxide but also large amounts of water (often up to 20% by volume), which has arisen, for example, in the preceding combustion of fuel or is formed by catalytic oxidation of the hydrocarbons, are present in the exhaust gas streams from, for example, internal combustion engines or burners. At the same time, the oxidation of the hydrocarbons requires an elevated temperature and additional heat is evolved by the oxidation of the hydrocarbons, so that peak temperatures of above 600° C. are attained.

The hydrothermal stability of the catalyst is therefore a decisive criterion in oxidative exhaust gas purification and the noble metal oxidation catalysts having zeolitic support material which are known from the prior art have the disadvantage of a lack of hydrothermal stability. It is an object of the invention to provide a catalytic method by means of which hydrocarbons, including, in particular, methane, in water-containing exhaust gas streams can be reduced effectively and in a stable manner over a prolonged time.

This object is achieved by a method of oxidizing short-chain hydrocarbons, in particular methane, in which a catalyst comprising a titanium-containing zeolite material which contains at least two noble metals is used. It has surprisingly been found that catalysts having a titanium-containing zeolite material which contains at least two noble metals have a high activity and are extremely hydrothermally stable.

The zeolite material here corresponds to the zeolitic support material in which the active noble metals are present. For the purposes of the present invention, zeolite materials encompass zeolites or zeotypes. According to the definition of the International Mineralogical Association (D. S. Coombs et al., Canadian Mineralogist, 35, 1979, p. 1571), zeolites are crystalline substances from the group of aluminum silicates which have a three-dimensional network structure and consist of SiO₄/AlO₄ tetrahedra which are linked via shared oxygen atoms to form a regular three-dimensional network. The zeolites are divided into various structure types in accordance with their topology. The zeolites are distinguished mainly according to the geometry of the voids and channels which are formed by the rigid network of the SiO₄/AlO₄ tetrahedra, i.e. the crystalline structure, and are characteristic of each structure type. Particular zeolites display a uniform structure having linear or zig-zag channels, e.g. the ZSM-5 structure with MFI topology, while in others there are relatively large voids behind the pore openings, e.g. in the case of the Y or A zeolites having the topologies FAU and LTA. An overview of the various structures and their topologies may be found in “Atlas of Zeolite Framework Types” (Ch. Baerlocher, W. M. Meier, O. H. Olson, Elsevier, 5^{th} revised edition, 2001).

Zeotypes are crystalline substances whose structure corresponds to that of zeolites but in contrast to zeolites some or all SiO₄/AlO₄ tetrahedra are replaced by foreign atoms in zeotypes; these foreign atoms can be, for example, P, N or Ti.

The zeolite material according to the invention can be, for example, a zeolite having the structure type MFI, BEA, MOR, MEL or CHA. Preference is given to zeolite materials of the structure type MFI or BEA. If a zeolite material of the structure type MFI is used, the zeolite material is particularly preferably a zeolite material of the TS-1 type, also known as titanium silicalite. Titanium silicalite is a crystalline zeotype material having tetragonal [TiO₄] and [SiO₄] units which are arranged in an MFI structure and whose pore openings have a ring size of 10. Due to this structure, TS-1 displays a three-dimensional pore system having pores which have diameters in the range from 5.1 to 5.6 Angstrom and represent the micropores of the system. TS-1 is commercially available, e.g. from the manufacturer Polimeri Europa SpA.

If a zeolite material of the structure type MEL is used, the zeolite material is particularly preferably a zeolite material of the TS-2 type. TS-2 is a titanium-containing crystalline zeolite material which corresponds structurally to ZSM-11. It has tetragonal [TiO₄] and [SiO₄] units which are arranged in an MEL structure and whose pore openings have a ring size of 10. Due to this structure, TS-2 displays a three-dimensional pore system having pores which have a diameter of 5.2 Angstrom and represent the micropores of the system.

The zeolite material is preferably a zeolite material of the TS-1 or TS-2 type. The zeolite material of the TS-1 type is also known as titanium silicalite and has the structure type MFI. The zeolite material of the TS-type is a titanium-containing crystalline zeolite material which corresponds structurally to ZSM-11 and has the structure type MEL.

The zeolite material according to the invention is either an aluminum-free zeolite or a silicon-rich zeolite, i.e. the proportion of Al or other metals which are not noble metals is small. For the purposes of the present invention, silicon-rich zeolites are zeolites which have a molar Si/metal ratio of greater than 10:1, preferably greater than 20:1.

The pore openings of the zeolites or zeotypes of the zeolite material according to the invention are formed by rings having ring sizes of 8, 10 or 12, where the figure indicated is the number of SiO₄/AlO₄ tetrahedra per ring of the opening. A person skilled in the art will here speak of narrow-, medium- and wide-pored zeolites. Preference is given according to the invention to medium- and wide-pored zeolites having pore openings having a ring size of 10 or more, particularly preferably having pore openings having a ring size of 12 or more.

The characteristic voids and channels of the zeolite materials can be occupied by water molecules and additional framework cations which can be exchanged. The catalytically active noble metals can be integrated atomically or in the form of clusters into the voids and channels of the zeolite material or be present on the outer surface of the zeolite material.

The titanium content of the zeolite material is preferably below 15% by weight, more preferably below 10% by weight, more preferably below 3% by weight, particularly preferably below 2% by weight and most preferably below 1% by weight, in each case based on the total weight of the titanium-containing zeolite material. The titanium is particularly preferably embedded predominantly in the form of titanium tetrahedra in the crystalline structure of the zeolite material, so that no or only little crystalline titanium dioxide is present. This is realized in zeolite materials of the TS-1 or TS-2 type, which preferably have a Ti content in the range from 0.2 to 1% by weight.

The noble metal-containing zeolite material present in the catalyst has to contain at least two noble metals, but can also contain more than two noble metals. The noble metal is preferably a noble metal selected from the group consisting of Pt, Pd, Rh, Ru, Cu, Ag and Au, with preference being given to a bimetallic combination of the noble metals Pt and Pd. If the bimetallic noble metal combination is made up of Pd and Pt, the noble metals are typically present in an atomic ratio of Pd/Pt of from 1:10 to 10:1, preferably from 5:2 to 7:2 and particularly preferably 3:1. The noble metals used in the catalyst are preferably in the pores of the zeolite material. It is therefore possible to select a method of synthesis which leads to the noble metals being entirely or predominantly present in the micropores of the zeolite and absent or present to only a small extent on the outer surface of the zeolite.

The catalyst according to the invention can be present as powder, as all-active catalyst or as coated catalyst, i.e. applied to a shaped body.

The pulverulent catalyst according to the invention can consist of the zeolite material loaded with noble metals, but it can also be mixed with auxiliaries such as binders before use.

An all-active catalyst can be formed by shaping of the pulverulent zeolite material loaded with noble metals, with, for example, an extruded shaped body or a monolith being formed. Further preferred shaped bodies are, for example, spheres, rings, cylinders, perforated cylinders, trilobes or cones, with a monolith such as a monolithic honeycomb body, for example, being particularly preferred. For this purpose, either the pure pulverulent zeolite material loaded with noble metals is shaped or else auxiliaries such as binders or porosity formers are added. Finally, the intermediate formed by the shaping operation is dried and finally calcined.

Furthermore, the catalyst according to the invention can be present as coated catalyst in which the catalyst is present as a layer on a shaped body. The noble metal-containing zeolite material can preferably be processed together with a preferably siliceous binder to give a washcoat and applied as washcoat coating to a shaped body. The mass ratio of binder/catalytic noble metal-containing zeolite material is in this case from 0.01 to 0.5, preferably from 0.02 to 0.3 and particularly preferably from 0.04 to 0.25, in each case based on the proportions of solids of binder and catalytically active composition. Finally, the raw still moist coated catalyst is dried and finally calcined.

The shaped body can be, for example, an open-pored foam structure, for example a metal foam, a metal alloy foam, a silicon carbide foam, an Al₂O₃ foam, a mullite foam, an Al titanate foam or a monolithic support structure having, for example, parallel channels which can be fluidically connected to one another or contain particular internals for inducing turbulence in the gas.

Shaped bodies which are likewise preferred are made, for example, of a metal sheet composed of any metal or a metal alloy and have a metal foil or sintered metal foil or a woven metal fabric and are produced, for example, by extrusion, rolling-up or stacking. In the same way, support bodies composed of ceramic material can be used. The ceramic material is frequently an inert low-surface-area material such as cordierite, mullite, alpha-aluminum oxide, silicon carbide or aluminum titanate. However, the support body used can also consist of high-surface-area material such as gamma-aluminum oxide or TiO₂.

The drying of the all-active catalyst or of the coated catalyst is effected by means of a drying step at temperatures in the range from 50 to 150° C., preferably from 80 to 120° C., for a period of more than two hours, preferably about 16 hours. The calcinations of the all-active catalyst or of the coated catalyst is effected by means of a calcination step, preferably at temperatures of from 300 to 600° C., more preferably from 400 to 550° C. The calcination time here is preferably from one to eight hours, more preferably from two to six hours and in particular from about three to five hours.

The introduction of the at least two noble metals into the zeolite material can be effected, for example, by impregnation with one or more, preferably aqueous, solutions which contain the noble metals in the form of precursor compounds. Impregnation can be carried out using all methods known to those skilled in the art. If the zeolite material is present as powder, impregnation of the zeolite material is preferably carried out by the “incipient wetness” method known to those skilled in the art.

If an all-active catalyst or a coated catalyst is to be obtained, this can be produced by shaping of the noble metal-containing zeolite material or by coating of a shaped body with a noble metal-containing zeolite material. As an alternative, the all-active catalyst or a coated catalyst can also be produced by impregnation of the shaped body or of the shaped body coated with the zeolite material with a noble metal-containing solution. The noble metal-containing solution is preferably an aqueous solution containing one or more noble metal precursor compounds. As noble metal precursor compound, it is possible to use, for example, nitrates, acetates, oxalates, tartrates, formates, amines, sulfides, carbonates, halides or hydroxides of the corresponding noble metals, with preference being given to nitrates. The noble metal precursor compounds should be essentially sulfur-free. It can also be preferred for the purposes of the invention for the noble metal precursor compounds to have the same anion, for example nitrate. If a bimetallic noble metal combination of Pd and Pt is employed, the Pt and Pd precursor compounds are preferably platinum nitrate or palladium nitrate.

The impregnation is optionally followed by a drying step. The drying step for the impregnated pulverulent zeolite material or the impregnated shaped body or all-active catalyst is preferably carried out at below the decomposition point of the noble metal precursor compound. The drying step preferably takes place in air. The drying temperatures are usually in the range from 50 to 150° C., preferably from 80 to 120° C. The drying time is preferably more than two hours, particularly preferably about 16 hours.

After the drying step, a step of calcination of the pulverulent zeolite material or the impregnated shaped body is carried out. The calcination step is preferably carried out at temperatures of from 300 to 600° C., more preferably from 400 to 550° C. The calcination time is preferably from one to eight hours, more preferably from two to six hours and in particular from about three to five hours.

The total loading of noble metal based on the zeolite material is in the range from 0.1 to 10% by weight, preferably in the range from 1 to 5% by weight, based on the total weight of the calcined noble metal-containing zeolite material.

The BET surface area of the noble metal-containing zeolite material is preferably in the range from 10 to 1000 m²/g, more preferably from 50 to 800 m²/g and most preferably from 300 to 700 m²/g. The BET surface area is determined by adsorption of nitrogen in accordance with DIN 66131.

The catalyst according to the invention displays a high aging stability in the presence of water. The exhaust gas stream preferably contains at least 1% by volume of water in gaseous form, and in particular the exhaust gas stream contains more than 5% by volume or more than 20% by volume of water in gaseous form.

Short-chain hydrocarbons are understood to mean alkanes or alkenes which have not more than five carbon atoms, including, in particular, methane, ethane, propane and also ethene and propene. Particular preference is given to alkanes which have not more than five carbon atoms, i.e. pentane(s), butane(s), propane, ethane or in particular methane. Particular preference is given to alkanes having fewer than three carbon atoms, including, in particular, methane.

The oxidation of the short-chain hydrocarbons is effected by means of an oxidant which is preferably a gaseous oxidant. The gaseous oxidant can be, in particular, molecular oxygen of the formula O₂ or O₃, a nitrogen oxide of the formula N₂O, NO or NO₂ or a mixture on these gaseous oxidants. If short-chain hydrocarbons in an exhaust gas stream are catalytically oxidized by means of the catalyst according to the invention, the oxidants are present in the untreated exhaust gas stream upstream of the catalyst.

### FIGURES

FIG. 1 shows the test results obtained in the testing of the inventive catalyst Pt/Pd TS-1 No. 1 and of the comparative catalyst Pt/Pd BEA No. 1. The measurements were carried out at a water content of in each case 0, 5, 10 and 20% by volume of H₂O, an oxygen content of 10% by volume of O₂ and a methane content of 0.1% by volume in the feed stream. After the step of increasing the water content in the feed gas, a further test was in each case carried out.

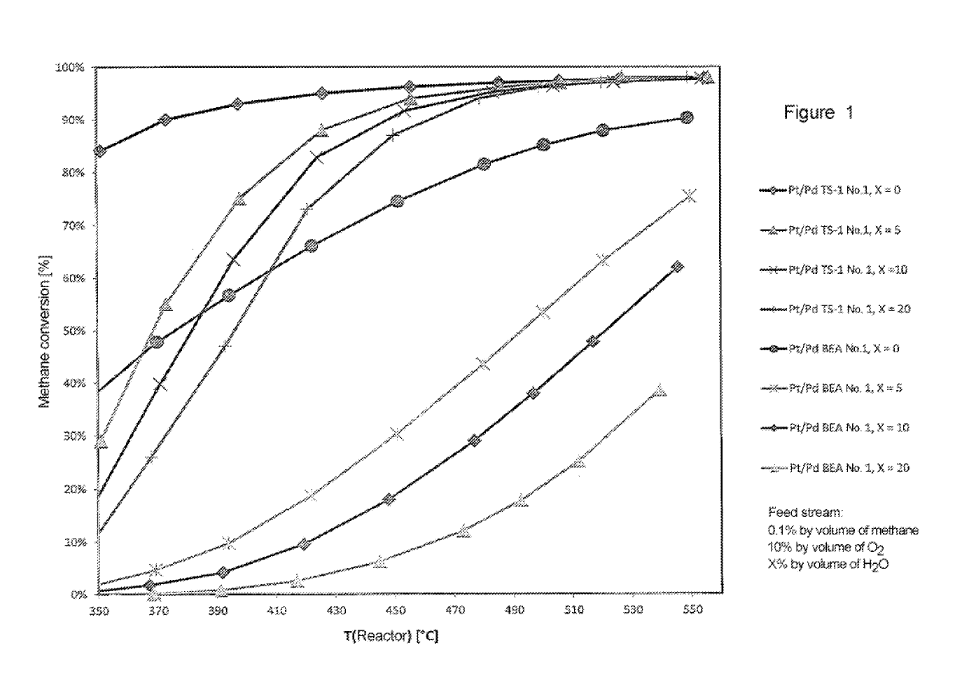

FIG. 2 shows the test results obtained in the testing of the inventive catalyst Pt/Pd TS-1 No. 1 as a function of various water contents in the feed gas. The catalyst according to the invention was measured in order in each case twice at 0% by volume of H₂O and at 10% by volume of H₂O in a feed gas stream which otherwise contained 0.1% by volume of methane and 10% by volume of O₂. Subsequently, a measurement was carried out at a reduced oxygen content of 0.2% by volume under otherwise unchanged conditions (the volume was kept constant by appropriate addition of nitrogen). Two hydrothermal aging steps followed, in each case followed by testing of the sample at 10% by volume of H₂O and 10% by volume of O₂ in the feed gas stream under otherwise unchanged conditions.

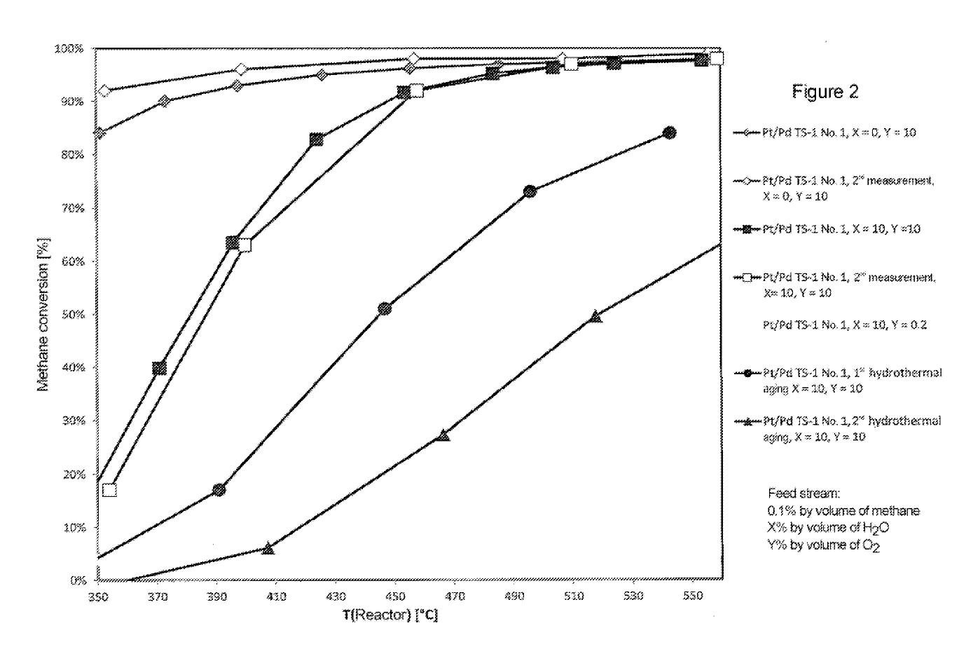

FIG. 3 shows the test results obtained in the testing of the comparative catalyst Pt/Pd Al₂O₃ No. 1 as a function of the water content in the feed gas. The catalyst was measured in order at 0% by volume of H₂O and 10% by volume of H₂O in a feed gas stream which otherwise contained 10% by volume of O₂ and 0.1% by volume of methane. Two hydrothermal aging steps followed, in each case followed by testing of the sample at 10% by volume of H₂O and 10% by volume of O₂ in the feed gas stream under otherwise unchanged conditions.

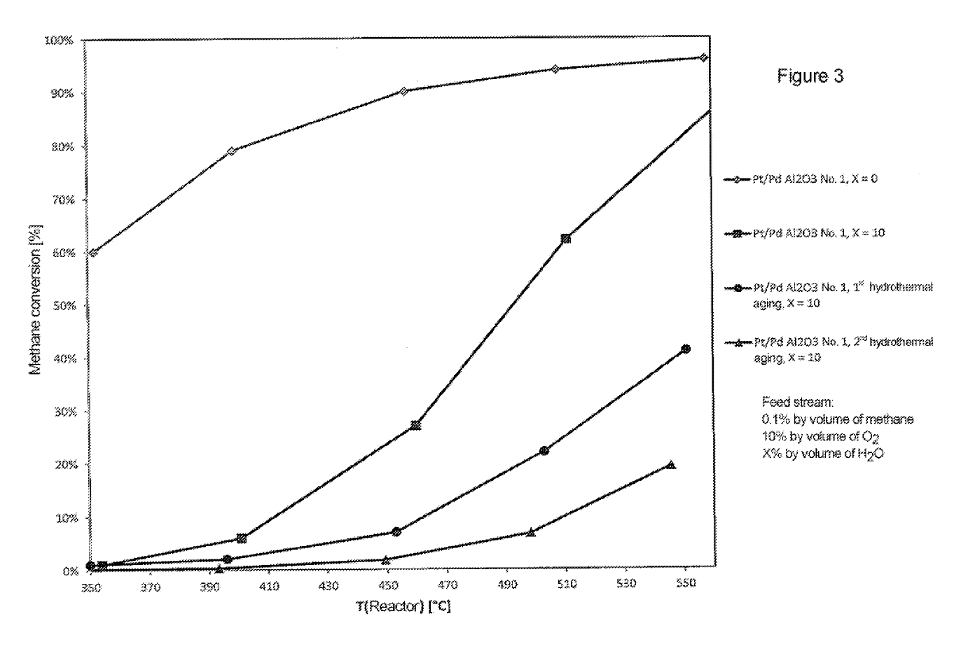

FIG. 4 shows the test results obtained in the testing of the comparative catalyst Pt/Pd BEA No. 1 as a function of various water contents in the feed gas. The catalyst was tested in order in each case twice at 0% by volume of H₂O and in each case once at 5, 10, 15 and 20% by volume of H₂O in a feed gas stream which otherwise contained 0.1% by volume of methane and 10% by volume of O₂. A hydrothermal aging step and testing of the sample at 10% by volume of H₂O and 10% by volume of O₂ in the feed gas stream under otherwise unchanged conditions followed.

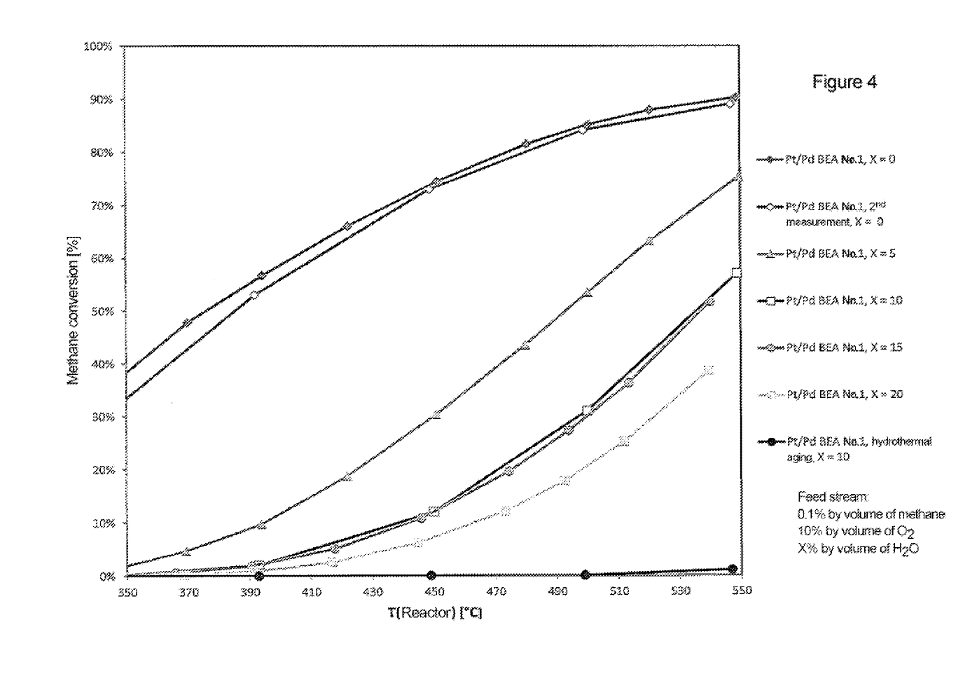

FIG. 5 shows the test results obtained in the testing of the catalysts according to the invention (Pt/Pd TS-1 No. 1) and of the comparative catalysts (Pt/Pd Al₂O₃ No. 1 and No. 2 and also Pt/Pd BEA No. 1 and No. 2). The catalysts were tested in a feed gas stream containing 0.1% by volume of methane, 0% by volume of H₂O and 10% by volume of O₂. Some of the catalysts were subsequently tested a second time under the same conditions (2^{nd} measurement).

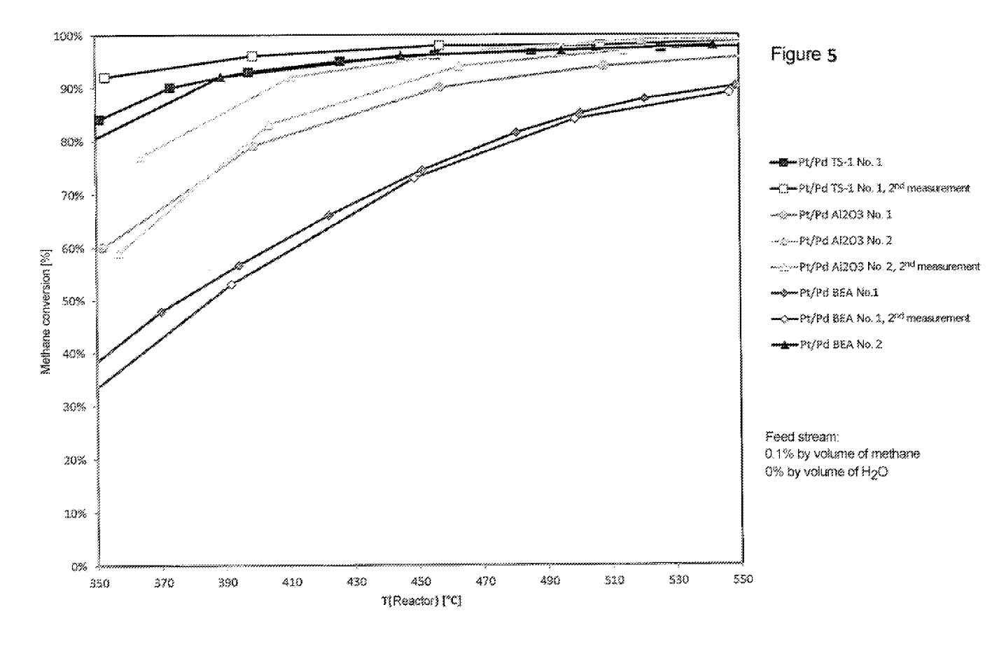

FIG. 6 shows the test results obtained in the testing of the catalysts according to the invention (Pt/Pd TS-1 No. 1) and of the comparative catalysts (Pt/Pd BEA No. and No. 2 and also Pt/Pd Al₂O₃ No. 1 and 2). The catalysts were tested in a feed gas stream containing 0.1% by volume of methane, 10% by volume of H₂O and 10% by volume of O₂. Some of the catalysts were subsequently tested a second time under the same conditions (2^{nd} measurement).

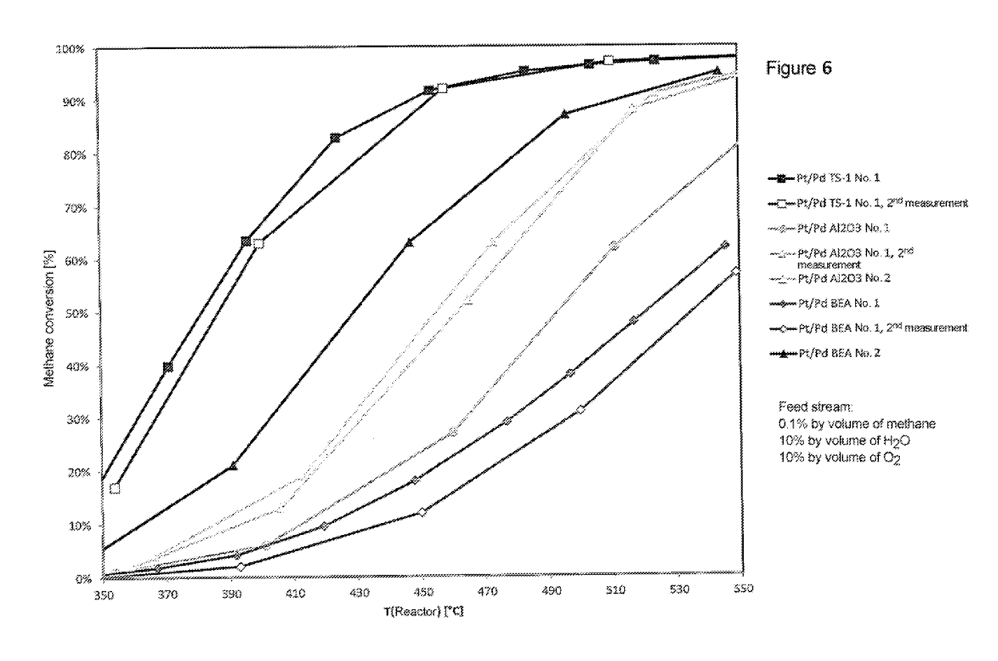

FIG. 7 shows the test results carried out in the testing of the catalyst according to the invention (Pt/Pd TS-1 No. 1) and of the comparative catalysts (Pt/Pd BEA No. 1 and 2 and also Pt/Pd Al₂O₃ No. 1 and 2) after a hydrothermal aging step. The measurement was in each case carried out in a feed stream containing 0.1% by volume of methane, 10% by volume of H₂O and 10% by volume of O₂.

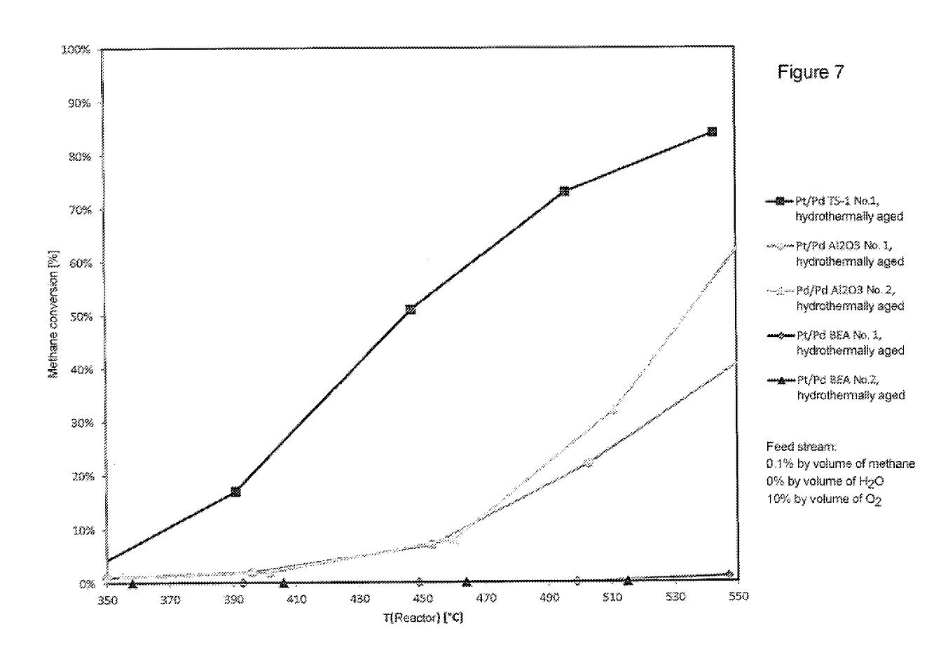

FIG. 8 shows the test results carried out in the testing of the catalyst according to the invention (Pt/Pd TS-1 No. 1) and of the comparative catalysts (Pt/Pd Al₂O₃ No. 1 and 2) after a second hydrothermal aging step. The samples Pt/Pd BEA No. 1 and 2 no longer showed any appreciable activity. The measurement was in each case carried out in a feed stream containing 0.1% by volume of methane, 10% by volume of H₂O and 10% by volume of O₂.

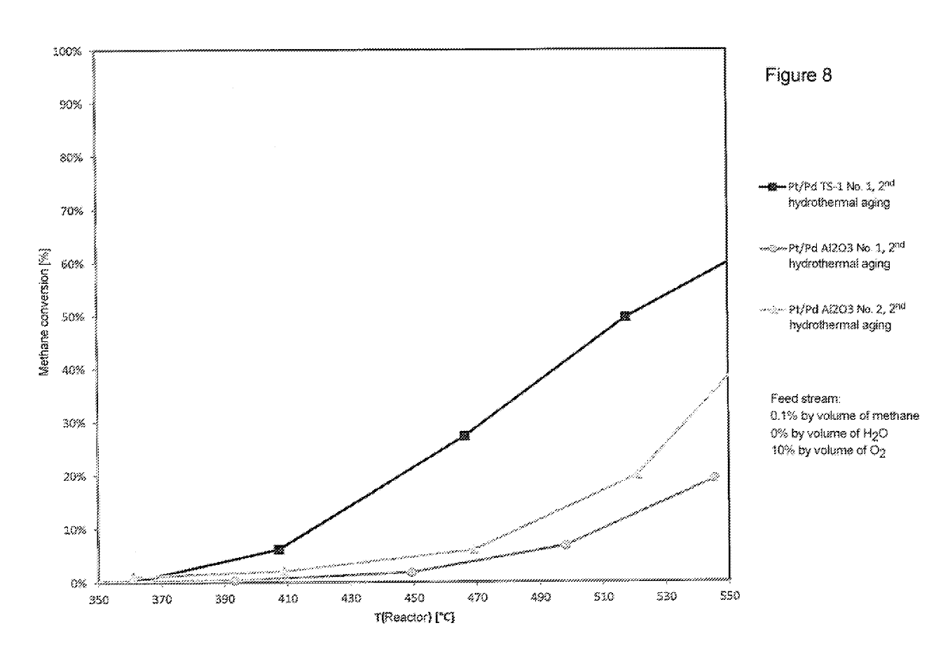

FIG. 9 shows the test results in the testing of the catalyst according to the invention (Pt/Pd TS-1 No. 2) and of the comparative catalysts (Pt/Pd SIL No. 1, Pt/Pd BEA No. 3 and 4 and also Pt/Pd Al₂O₃ No. 3 and 4) in a measurement using a feed gas mixture which simulates the exhaust gas from a gas engine. The feed gas mixture contained 3% by volume of H₂O, 10% by volume of O₂, 0.08% by volume of CO and 0.1% by volume of methane (together with other hydrocarbons). The samples were in each case tested one more time after a hydrothermal aging step.

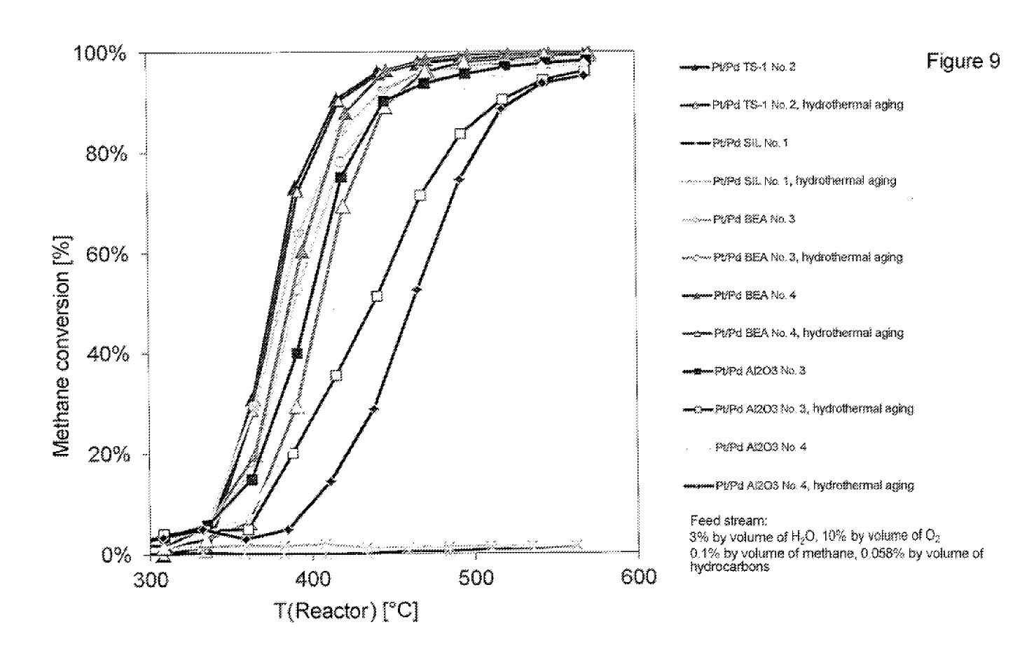

FIG. 10 shows the test results obtained in the time-dependent testing of the catalyst according to the invention (Pt/Pd TS-1 No. 2) and of the comparative catalysts (Pt/Pd BEA No. 3 and 5 and also Pt/Pd Al₂O₃ No. 3). The measurement was carried out at a temperature of 550° C. using a feed gas mixture which simulates the exhaust gas of a gas engine. The feed gas mixture contained 3% by volume of H₂O, 10% by volume of O₂, 0.08% by volume of CO and 0.1% by volume of methane (together with other hydrocarbons).

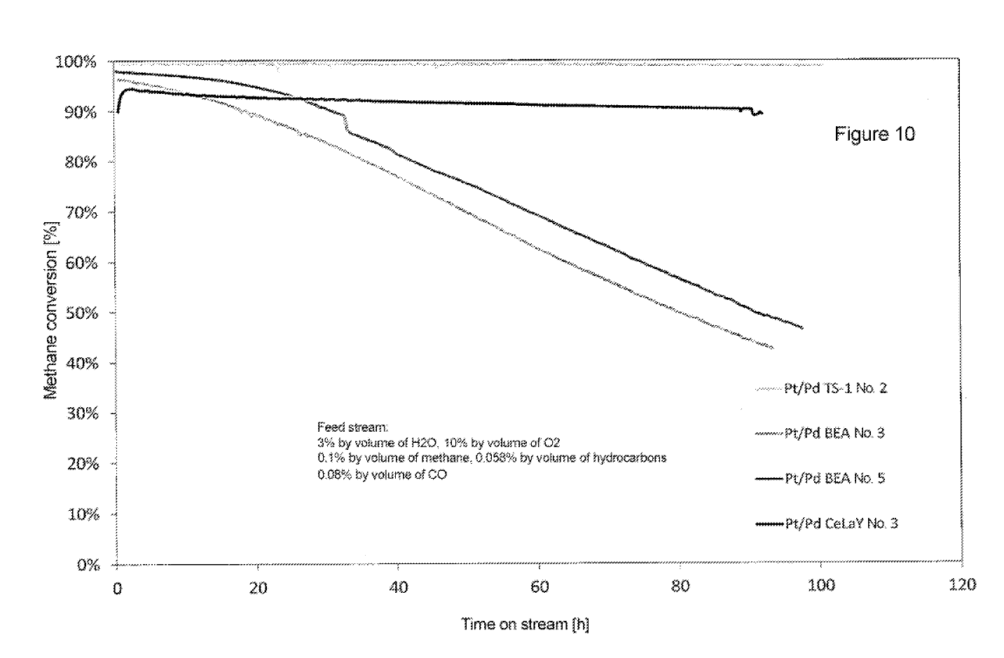

### MEASUREMENT METHODS

### Elemental Analysis Using ICP

The ICP-AES (inductively coupled plasma atomic emission spectroscopy) for determining the elemental composition and the SiO₂/Al₂O₃ ratio was carried out using the ICP Spectro Modula/Arcos instrument. Chemicals used were: sulfuric acid 98% AR, hydrofluoric acid 37% AR, hydrochloric acid 37% AR. The sample was finely milled.

To determine the Si and Al content, 100 mg of sample were weighed into a 100 ml plastic beaker and admixed with 1 ml of sulfuric acid and with 4 ml of hydrofluoric acid. The sample was digested at 85° C. in a water bath for five minutes until a clear solution was formed. The mixture was then cooled, made up to the mark and shaken. All elements were measured on the ICP, as were corresponding standards. Si was measured using the following settings: wavelength: 288.158 nm. Al was measured using the following settings: wavelength: 396.152 nm.

For Pt and/or Pd, an amount of sample such that about 3 mg of Pt or Pd were present was weighed out. 6 ml of hydrofluoric acid and 6 ml of hydrochloric acid were subsequently added. The mixture was then heated at 180° C. for 30 minutes while stirring in order to produce a clear solution. The mixture was then cooled, made up to the mark and shaken. All elements were measured on the ICP, as were corresponding standards. Pt was measured using the following settings: wavelength: 214.423 nm. In the case of Pd, the wavelength was: 324.270 nm.

All standards were made up with matching amounts of HF and HCl or H₂SO₄. The evaluation was carried out according to the following calculation:

w(E*in percent)=β(E*measured value in mg/1)×V(volumetric flask in 1)×100/m(amount weighed out in mg)

(E*=respective element).

### BET Surface Area:

The specific surface area of the materials was determined by the BET method in accordance with DIN 66131; the BET method is also published in J. Am. Chem. Soc. 60, 309 (1938). The sample to be determined was dried at 350° C. under vacuum in a fused silica tube (F=50 ml (min) for 1.5 h). The reactor was then cooled to room temperature, evacuated and dipped into a Dewar vessel containing liquid nitrogen. The nitrogen adsorption was carried out at 77 K using an RXM 100 sorption system (Advanced Scientific Design, Inc.).

### EXAMPLE 1

### Production of the Catalyst According to the Invention Based on TS-1

A zeolite of the TS-1 type was impregnated with a platinum nitrate and palladium nitrate solution using the insipient wetness method. For this purpose, the water absorption of the zeolite was determined and a corresponding amount of impregnation solution (228.5 ml) was added to 500 g of TS-1. During the impregnation, the mixture was continually stirred and it was ensured that homogeneous impregnation occurred. The powder was subsequently transferred to a calcination dish.

The powder was dried at 90° C. for 16 hours. The material was subsequently flushed with argon in a special furnace for about five minutes and heated from room temperature to 550° C. at a rate of 2° C. per minute. After calcination at 550° C. under argon for five hours, the mixture was cooled to room temperature over a period of three hours.

The calcined Pd/Pt TS-1 was stirred at 20% by weight in Bindzil 2034 DI suspension (amorphous silica sol from Eka Chemicals AB, Bohus, Sweden) and water to give a homogenous suspension. The suspension was dispersed by means of an Ultraturax for five minutes to give a washcoat having a D₅₀ of from 3 to 4 μm. The washcoat was then applied to a cordierite honeycomb (200 cpsi) by dipping the support into the washcoat. After dripping-off and blowing-out of the support by means of compressed air, a target loading of about 160 g/l was obtained. The coated honeycomb was dried overnight at 120° C. in air and subsequently calcined at 550° C. in air for three hours.

TABLE 1
Synthesized catalysts according to the invention based on TS-1

| | | | | Composition | |
|---|---|---|---|---|---|
| | | | | of zeolite | |
| | | | | material² | |
| | Zeolite | Pt | Pd | TiO₂:SiO₂ | Loading |
| Designation | material | [g/l]¹ | [g/l]¹ | [% by wt] | [g/l]¹ |
| Pt/Pd TS-1 | TS-1 | 0.998 | 2.841 | 2.87:97.13 | 150.3 |
| No. 1 | | | | | |
| Pt/Pd TS-1 | TS-1 | 1.04 | 2.98 | 2.87:97.13 | 157.4 |
| No. 2 | | | | | |

¹In each case based on the volume of the honeycomb.
²Without noble metals

### COMPARATIVE EXAMPLE 1

### Production of the Comparative Catalyst Based on Zeolite BEA-150

Two comparative samples were produced by the same production method as described under example 1, with the difference that zeolite beta was used as starting material and was calcined in air after impregnation. The approximate target loading was in each case about 140-200 g/l, based on the volume of the honeycomb. The honeycombs coated according to this example correspond to the catalysts having the designations Pt/Pd BEA No. 1-5 which serve as comparison.

TABLE 2
Synthesized comparative catalysts based on zeolite beta

| | | | | Composition | |
|---|---|---|---|---|---|
| | | | | of zeolite | |
| | | | | material² | |
| | Zeolite | Pt | Pd | Al₂O₃:SiO₂ | Loading |
| Designation | material | [g/l]¹ | [g/l]¹ | [% by wt] | [g/l]¹ |
| Pt/Pd BEA | BEA | 0.849 | 2.397 | 1.1:98.9 | 153.5 |
| No. 1 | | | | | |
| Pt/Pd BEA | BEA | 0.766 | 2.163 | 0.9:99.1 | 138.5 |
| No. 2 | | | | | |
| Pt/Pd BEA | BEA | 0.96 | 2.78 | 0.7:99.3 | 199.4 |
| No. 3 | | | | | |
| Pt/Pd BEA | BEA | 0.80 | 2.64 | 1.1:98.9 | 199.4 |
| No. 4 | | | | | |
| Pt/Pd BEA | BEA | 0.82 | 2.31 | 1.1:98.9 | 148.0 |
| No. 5 | | | | | |

¹In each case based on the volume of the honeycomb.
²Without noble metals

### COMPARATIVE EXAMPLE 2

### Production of the Honeycomb Coated with Noble Metal-Containing Aluminum Oxide

A comparative sample was produced employing the same production method as described under example 1, with the difference that a gamma-aluminum oxide stabilized by doping with rare earth metals (referred to as Al₂O₃) was used as starting material. The approximate target loading was in each case 50 g/l or 100 g/l, based on the volume of the honeycomb. The honeycombs coated according to this example correspond to the catalysts having the designations Pt/Pd Al₂O₃ No. 1-4 which serve as comparison.

TABLE 3
Synthesized comparative catalysts based on aluminum oxide

| | | | | Composition | |
|---|---|---|---|---|---|
| | | | | of support | |
| | | | | material² | |
| | Metal | Pt | Pd | Al₂O₃:rare earths | Loading |
| Designation | oxide | [g/l]¹ | [g/l]¹ | [% by wt] | [g/l]¹ |
| Pt/Pd Al₂O₃ | Al₂O₃ | 0.33 | 2.04 | 90:10 | 51.4 |
| No. 1 | | | | | |
| Pt/Pd Al₂O₃ | Al₂O₃ | 0.35 | 3.69 | 90:10 | 92.0 |
| No. 2 | | | | | |
| Pt/Pd Al₂O₃ | Al₂O₃ | 0.62 | 1.85 | 90:10 | 99.0 |
| No. 3 | | | | | |
| Pt/Pd Al₂O₃ | Al₂O₃ | 0.35 | 2.1 | 90:10 | 99.0 |
| No. 4 | | | | | |

¹In each case based on the volume of the honeycomb.
²Without noble metals

### COMPARATIVE EXAMPLE 3

### Production of the Comparative Catalyst Based on Zeolite Silicalite

A comparative example was produced by the same production method as described under example 1, with the difference that a zeolite of the silicalite type was used as starting material. The approximate target loading was in each case 165 g/l, based on the volume of the honeycomb. The honeycomb coated according to this example corresponds to a catalyst serving as comparison and is designated as Pt/Pd SIL No. 1.

TABLE 4
Synthesized comparative catalysts based on silicalite

| | | | | Composition | |
|---|---|---|---|---|---|
| | | | | of zeolite | |
| | | | | material² | |
| | Zeolite | Pt | Pd | Al₂O₃:SiO₂ | Loading |
| Designation | material | [g/l]¹ | [g/l]¹ | [% by wt] | [g/l]¹ |
| Pt/Pd SIL | Silicalite | 0.83 | 2.49 | 0:100 | 165.7 |
| No. 1 | | | | | |

¹In each case based on the volume of the honeycomb.
²Without noble metals

### Hydrothermal Aging

To simulate aging of the catalysts, a process step of hydrothermal aging in which the aging effects occurring during operation are established at an accelerated rate was carried out. For this purpose, the sample was heated to 700° C. and treated for 24 hours with a gas containing 10% by volume of water and 10% by volume of oxygen. The process of hydrothermal aging was in some cases carried out a number of times.

### Testing

The samples were tested for catalytic activity in the oxidation of methane. For this purpose, a feed stream containing 0.1% by volume of methane (1000 ppmv), 10% by volume of O₂ and from 0 to 20% by volume of H₂O and otherwise nitrogen as carrier gas was used. In some experiments, a reduced oxygen concentration of 0.2% by volume was employed. In order to simulate the exhaust gas stream from a gas engine, a specific gas mixture containing 3% by volume of H₂O, 10% by volume of O₂, 0.08% by volume of CO, 0.1% by volume of methane, 0.02% by volume of ethane, 0.02% by volume of ethene, 0.018% by volume of propane was used.

The throughput rate (gas hourly space velocity) was 40 000 h⁻¹ in all experiments, and the addition of carrier gas was adjusted so that the throughput rate remained constant in each case despite different gas concentrations. The sample was in each case heated to 550° C. at a rate of 50° C./min and measured in the temperature range from about 550° C. to 350° C. with a decreasing temperature ramp. Analysis of the gas composition upstream and downstream of the catalyst was carried out by means of an FTIR spectrometer.

1. A method of oxidizing alkanes having not more than five carbon atoms, comprising the step of using a catalyst comprising a zeolite material containing titanium and at least two noble metals, wherein the zeolite material is a zeolite material of the TS-1 or TS-2 type.

2. The method as claimed in claim 1, wherein the crystalline structure of the zeolite material contains Ti atoms.

3. The method as claimed in claim 2, wherein the Ti atoms are tetrahedrally coordinated.

4. The method as claimed in claim 1, wherein the at least two noble metals are selected from the group consisting of Pt, Pd, Rh, Ru, Cu, Ag and Au.

5. The method as claimed in claim 1, wherein the at least two noble metals are Pt and Pd.

6. The method as claimed in claim 5, wherein the at least two noble metals Pd and Pt are present in an atomic ratio of from 1:10 to 10:1.

7. The method as claimed in claim 1, wherein the at least two noble metals are present in the pores of the zeolite material.

8. The method as claimed in claim 1, wherein the catalyst has been applied to a shaped body composed of metal or ceramic.

9. The method as claimed in claim 1, wherein an exhaust gas stream is treated by the method.

10. The method as claimed in claim 9, claim 1, wherein the exhaust gas stream contains at least 1% by volume of water.

11. The method as claimed in claim 9, wherein the exhaust gas stream contains more than 20% by volume of water.

12. The method as claimed in claim 1, wherein the oxidation of the alkanes having not more than five carbon atoms is effected by means of a gaseous oxidant.

13. The method as claimed in claim 12, wherein the gaseous oxidant is molecular oxygen or a nitrogen oxide.

14. A catalyst comprising a zeolite material of the TS-1 or TS-2 type containing at least two noble metals for oxidizing alkanes having not more than five carbon atoms in exhaust gas streams.

15. The method as claimed in claim 5, wherein the at least two noble metals Pd and Pt are present in an atomic ratio of from 5:2 to 7:2.

16. The method as claimed in claim 9, wherein the exhaust gas stream contains more than 5% by volume of water.
